(19) United States
(12) Patent Application Publication
(10) Pub. No.: US 2008/0263958 A1
(43) Pub. Date: Oct. 30, 2008

(54) CLASSROOM FORTIFICATION SYSTEM

(76) Inventor: Frederick Carr Edson, Charleston, SC (US)

Correspondence Address: PASSE' INTELLECTUAL PROPERTY, LLC, 1717 BRASSFIELD RD., RALEIGH, NC, 27614, US

(21) Appl. No.: 11/941,455

(22) Filed: Nov. 16, 2007

Related U.S. Application Data
(60) Provisional application No. 60/913,563, filed on Apr. 24, 2007.

(51) Int. Cl. E06B 9/04

(52) U.S. Cl. 49/56; 49/506

(57) ABSTRACT

The present invention relates to a device and method for preventing entry into a room having an upper window such as a school classroom door. Specifically, the device is an entry resistant material positioned on the lower part of the inside of the classroom door which can be moved into position over the inside of the classroom door window and prevent or resist entry into the window and optionally restrict viewing into the classroom.

This application claims priority of U.S. application Ser. No. 60/913,563 filed on Apr. 24, 2007 and incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a door reinforcement apparatus for use on door windows. In particular, the present invention is a door window reinforcement device designed to be engaged to prevent or resist entry into a room such as a classroom through the window on the classroom entry door. It also relates to the prevention of someone from using the classroom door window as a means of aiming or entry for a weapon, projectile or the like from outside the classroom.

2. Description of Related Art

It is clear that school related shooting events have increased in frequency and number of deaths over the years. The open nature of school environments makes security against unauthorized intruders or even authorized students with weapons difficult to eliminate or control. Frequently, faculty and students in classrooms are essentially trapped in the presence of an assassin and because of the arrangement of classrooms there is little means for escape. As a result, classrooms are often the site of mass killings unless there has been an armed person to defend the situation or there has been a way to barricade the entry door. Schools are often weapon free zones thus eliminating one effective means to defend the classroom and very few classroom doors have been provided with even a simple lock to prevent entry by intruders.

Typically, school classroom doors consist of a standard 3 foot wide door with a upper glass plate window. The door windows are often a mandated item, allowing observation of the classroom from the hallway to monitor the activity within the classroom. The more recent events with shooters in schools mean that more and more school classroom doors have interior locks. In U.S. Pat. No. 6,860,129 Issued Mar. 1, 2005 to Eller et al. there is described a security classroom function lock mechanism for giving control of the locked state of the classroom door. However, even with the best door lock installed on classroom doors, the door window remains the weak link in the entry into the classroom. Regular glass or even glass reinforced with wire can be knocked or shot out and an individual with a weapon can gain entry. Even further, as long as any kind of hole can be made in the glass, the individual with a weapon can stick the weapon inside the classroom, aim by looking in the window and fire without entering the classroom, the clear window giving a shooter the ability to see the people inside. One solution that does work is bullet proof glass. Bullet proof glass is extremely expensive costing as much or more than one thousand dollars per door to install. Even further, many doors are either not strong enough or thick enough to accommodate bullet proof glass necessitating replacing the entire door as well as in most cases the door framing. Many schools simply don't have that kind of budget to add bullet proof glass and replace all their doors. Even further, fire laws for most areas may make a reinforced bulletproof glass door non-compliant with the local code.

Reinforcement of a door itself has been suggested in general and in U.S. Pat. No. 5,967,216 issued Oct. 19, 1999 to Mancini there is described a general door reinforcing means which protects the framing but not a door window. Other approaches have been used to prevent an intruder from accessing the classroom but are equally if not extraordinarily more expensive. In US patent application 2004/0262383 published Dec. 30, 2004 to Sielinski there is described an access portal which separates people on one side from the other side. This approach is totally impractical in the school setting and is more practical in transportation vehicles such as school busses. An approach that can work successfully is to redesign the layout of the school buildings from the construction phase. By originally building the classrooms different to begin with much more control over access can be obtained. In U.S. Pat. No. 6,330,771 Issued Dec. 18, 2001 to Hester, there is described a modular design to building a school wherein a safe school complex is designed around a central courtyard and each classroom having two doors one to the outside and one to the courtyard. Obviously, while this can give students a way to escape, tearing down existing schools to rebuild is not a practical solution.

Methods for making a door more impenetrable as a whole have been introduced, not for school classrooms but in general for security issues. In U.S. Pat. No. 4,359,081 Issued Nov. 16, 1982 to Brower there is described a horizontally operated door barrier which makes the doorway virtually impenetrable while allowing access as necessary. In U.S. Pat. No. 4,921,033 issued May 1, 1990 to Finch, et al, there is described a security system using a roll up door system which completely covers a door. While these methods effectively prevent entry they block the legally mandated classroom door view window, are extremely costly, are not usable in accordance with the ADA mandate for the handicapped and require room to install that most classrooms simply do not have.

It would be of value if there was a low cost solution that could be used with classroom doors to prevent or resist entry through the door window, was easy to use, and met all applicable local fire and safety codes. It is an object of the present invention to address these issues.

### BRIEF SUMMARY OF THE INVENTION

The present invention relates to a classroom door that is either fitted with or retrofitted with a fortification device that addresses the problems and concerns present in the prior art. Specifically, a device that resides on the door which can be moved into place over the door window which allows view into the classroom, usable by most anyone in the classroom and prevents or resists entry into the window of most any kind is disclosed.

Specifically the present invention relates to a safety device to reinforce a classroom door window comprising:
a) a piece of entry resistant material sufficient to cover the door window;
b) a means for attaching the device to the classroom door beneath the door window;
c) a means for moving the device from beneath the door window to a position completely covering the door window; and
d) a means for removably locking the device in position completely covering the door window.

In yet another embodiment of the present invention relates to a method of securing the inside portion of a classroom door window in an emergency comprising:
a) positioning a piece of entry resistant material over the inside portion door window; and
b) removably locking the material in place such that it completely covers the inside portion door window;
   wherein the entry resistant material is positioned on a bottom portion of the inside portion of the classroom door prior to positioning over the window.

These and other objects of the present invention will be clear when taken in view of the detailed specification and disclosure in conjunction with the appended figures.

### BRIEF DESCRIPTION OF THE DRAWINGS

FIG. 1a is a perspective view of an embodiment of the invention mounted on the inside of a classroom door.

FIG. 1b is a perspective view of an embodiment of the invention in the process of being deployed by sliding into position.

FIG. 1c is a perspective view of the present device employed over a classroom door window.

FIG. 2 is an alternate embodiment of the invention which folds up to cover the classroom door window.

### DETAILED DESCRIPTION OF THE INVENTION

Prior to the present invention there has been no device or method available which cheaply and effectively prevents entry into a school classroom door window either to impede personal entry or to prevent someone from being able to use the window as a means to operate a weapon such as a gun and shoot into a classroom. It has been discovered in the present invention that application of a device which positions entry resistant material at the bottom of the door and which can be positioned quickly to lock in place over the inside portion of the classroom door window when desired, achieves those objectives.

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein the term “entry resistant material” refers to lightweight, inexpensive materials that enhance resistance or prevent entry when held in place over an opening. Such materials as security wire screening, wire mesh, plastic screening, security plastic sheeting such as Kevlar, sheet metal, and other bulletproof lightweight plastics and the like are suitable. Synthetic bars if lightweight and polymeric or very lightweight metal and the like are also acceptable choices. It does not include heavy steel bars, and the like which while very resistant are either too heavy, too thick or too costly to fabricate into an effect product and mount on a door and to be used by anyone within the classroom. Too heavy is especially a problem since such a device may need to be ADA compliant and a heavy material may not be able to be positioned over the window or occupants who are unable to lift the material.

Typically, the window in a classroom door is a rectangle (often a square) somewhere from about 12 to about 36 inches, give or take, on a side. In order to be protective, the entry resistant material will need to be of a size sufficient to cover the window and not leave the glass uncovered. Since the lightweight materials of the present invention used as entry resistant material tend to be flexible and they need to be locked in position over the window, the material is usually mounted in a frame. The frame either of metal, plastic wood or the like will hold the entry resistant material taught and enable the movement of the material into place over the window. In one embodiment the entry resistant material is slightly bigger in circumference than the window it is covering, while in another embodiment it is roughly the same size.

The material selected can also be non-opaque, semi-opaque or opaque depending on the desired effect and the local rules. It is possible that local ordinance prevents a completely opaque covering and while this provides the best protection, semi-opaque materials provides much more protection that completely sheer windows or sheer entry resistant materials. Security screening material is typically semi-opaque while Kevlar and other plastics of the same kind typically are opaque as a non-limiting example.

As used herein the phrase “means for attaching the material to the classroom door beneath the door window” refers to the positioning of the device during non use. Classroom door windows typical are positioned in the upper half to upper one third of the door so that viewing may be done while in the standing position. The present device is positioned under the window on the classroom side of the door when not in use. When so positioned the door is not affected nor inhibited during use, the means may be by any one of several methods. In one embodiment (which can be seen in the drawings) the entry resistant material is positioned in a sliding frame which holds the material beneath the window when not in use and then allows the material to move up into position. Likewise, in other embodiments (which can be seen in the drawings), the entry resistant material is positioned beneath the window in such a way that it can be moved into position over the window when desired. Any convenient means can be used and frequently the means for moving the material can serve to position the material beneath the window as well as serve the function of positioning the material over the window. One skilled in the art will be able to fashion appropriate means in addition to the presently disclosed embodiments in view of the disclosure herein.

As described above, the entry resistant material is positioned under the window when not in use and then moved to a position covering the window while in use. As used herein a “means for moving the device from beneath the window to a position covering the door window” refers to setting up a quick and easy mechanism for moving the entry resistant material from beneath the window to a position covering the window and thus providing protection or resistance from entry through the window or from someone sticking an arm or weapon into the classroom via the window. Based on the disclosure herein a number of different methods could be employed. In one embodiment, the device is mounted in slide tracks. The material, optionally in a frame, can then be slid from a down position (held in place by gravity to an up position which can be locked (reversibly) in place to provide protection. In one embodiment, there are a series of lock stops or a ratcheting mechanism in the track so that the material can stop at any one of several positions and lock in place in the event there is not enough time to raise the material all the way to the top. In another embodiment, the entry resistant material is foldably hinged such that the material can fold into place. Since in general the shape of the material is flat, folding the material upwards allows for easy engagement and positioning against the window. Further since the material is lightweight, movement from the lower position to being in place over the window can be achieved within the ADA constrains for safety devices. In yet another embodiment instead of manually moving the entry resistant material from its position on the lower part of the door to the upper part of the door covering the window, there can be an automatic device. In one embodiment, springs could be used to release and catapult the material into place. Such a method could be adapter for both of the previous embodiments and one skilled in the art in view of this disclosure could easily fashion other means to automatically position the material over the window. While ease in positioning the material back in the down position after use would be desirable since a worker, student or other person could reposition the device, the return trip to the bottom of the door need not meet ADA criteria and reloading springs or the like can be done later by a technician or the like.

Once the material is in place covering the door window, it is important that if the window is broken from the outside that the material cannot be easily pushed back out of the way from outside the classroom. Accordingly, once the entry resistant material is positioned covering the door window, it will have a “means for removably locking the device in position”. Thus once locked, it can only be removed by unlocking the device (since it is removably locked) from the inside. The means can be by any convenient means for locking the type of material chosen. In one embodiment, it is a plurality of latches. In other embodiments it is clips, deadbolts or the like. One further embodiment is click stops or a ratcheting mechanism. In yet another embodiment it is a spring loaded latching means which engages merely by positioned the entry resistant material in place over the door window. Since it may be necessary for the school administration, the police or the like to gain entry to the classroom from the outside or remove the device from the outside, in one embodiment there is a keyed means for unlocking the material once locked. By keyed is meant that a device other than just the hands or the like is necessary to remove the device from the outside. A key, computer id, or the like can conveniently be used.

In one embodiment, the door is also locked in a closed position when engaging use of the device of the present invention. A means such that the door is also locked can be included in the invention. In one embodiment the device has deadbolts or the like which when the entry resistant material is positioned over the door window it also engages bolts bars, the door lock or any like means for locking the door at the same time. In one embodiment wherein the material is in a slidable tract the top of the material has one or more bolts which move into position across the door and door frame to lock the door closed. Other means could easily be fashioned.

In use then the device would normally remain where the entry resistant material is positioned underneath the door window. In the event of a school intruder someone inside the classroom would engage the means for positioning the device over the window and then lock the device in place. In one embodiment the door is also locked either separately or as an embodiment of the device of the invention itself.

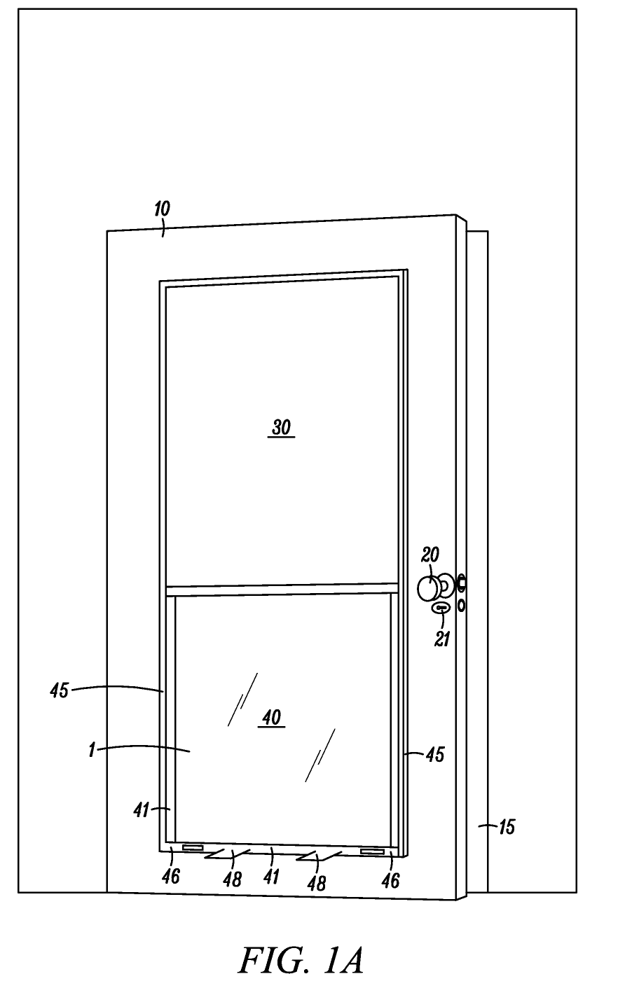

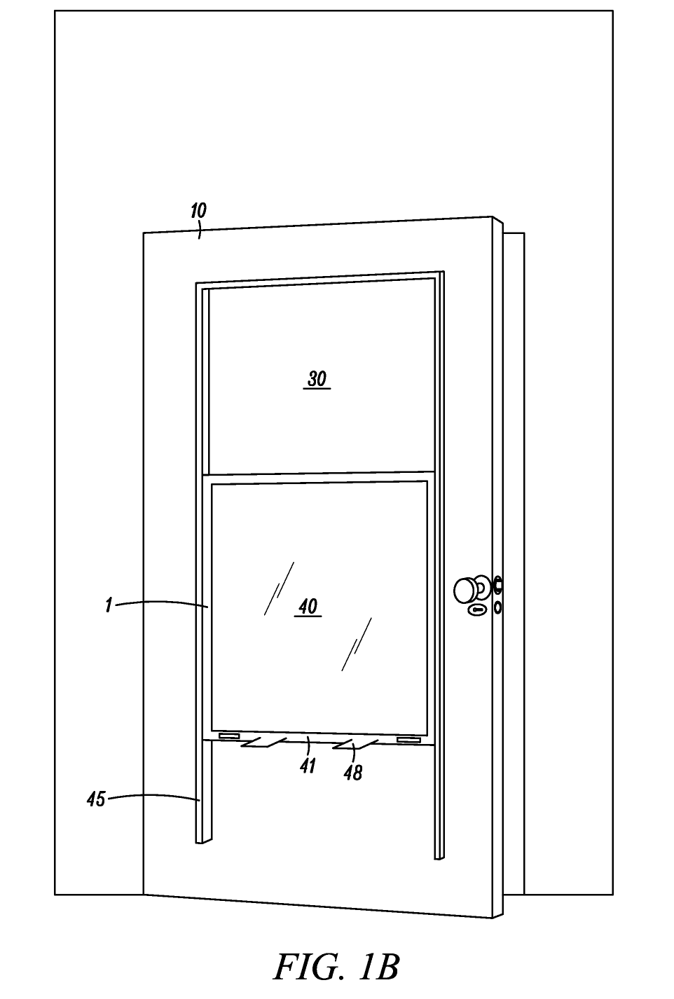

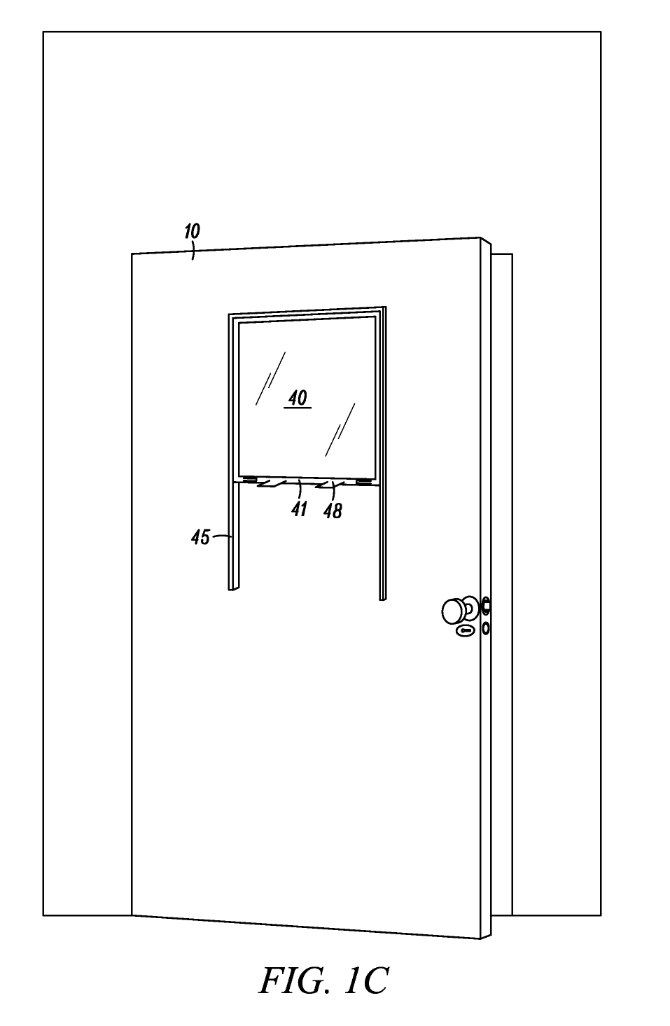

Now referring to the drawings, FIG. 1a is a perspective view of an embodiment of the present invention classroom door window fortification 1 mounted on classroom door 10 as seen from inside a classroom. Classroom door 10 is shown open with a small bit of doorway 15 showing. In use, a particular user would grab the doorknob 20 and push the door 10 to a closed position. The user would then lock the door 10 using door lock 21. At this point the door is locked but an intruder could break glass window 30 and either reach in and unlock the door or shoot from the outside through the glass 30 aiming from an outside of the classroom position.

The window fortification 1 is seen mounted in its further most down position. It consists, in this embodiment, of entry resistant material 40 (such as resistant screening material or Kevlar or the like) in frame 41. The frame 41 is slidably mounted in slide channels 45 which hold the frame 41 in the lowest position and prevent the frame from falling out on the floor by use of stops 46. To begin lifting the fortification 1 into position to cover window 30 a user could grab handles 48 or the frame and begin to lift straight up.

FIG. 1b is a perspective view of the fortification device 1 of the present invention in the process of moving into position over window 30. Here the device 1 is moving upward in the channels 45 and is about halfway to covering the window 30. In this position if the user lets go of the handles the device 1 will return to the lower position seen in FIG. 1a by gravity.

FIG. 1c is a perspective view of the fortification device 1 of the present invention in place over a classroom door window 30 (not seen in this view due to being covered by fortification device 1). In this embodiment the door window is a much smaller window and the device 1 has been sized accordingly as an example of the scalability of the device. The window 30 in this embodiment is a much smaller window and as such the device 1 is shown relatively smaller but identical in operation. In this position the device 1 can lock into position over the window by any number of means. There can be spring loaded means which when the device 1 is in place lock the device 1 into an upper most position completely covering the window. As an alternate embodiment the device 1 could have clips which manually hold the device in place and prevent gravity from returning the device to its lower position of FIG. 1a. When the situation requiring fortification is ended the clips or spring means or the like can be disengaged and the device 1 purposefully returned to the lower position until it is needed once again.

In the engaged up position the device 1 of the present invention prevents entry of either the individual or a part of the individual. When the entry resistant material is semi-opaque or opaque, it also prevents visual sighting within the classroom and this prevents an intruder from knowing if or where people are in the classroom. The device of the present invention thus provides a relatively inexpensive way to fortify the classroom door without addition of costly doors or add-ons as previously done in the classroom.

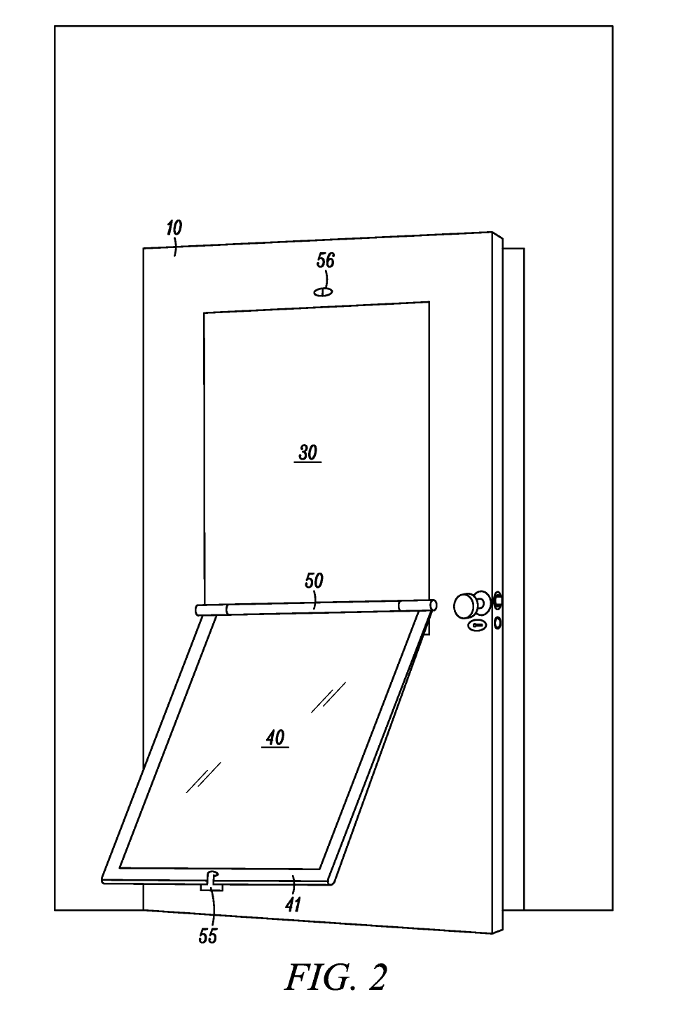

In FIG. 2 there is shown an alternate embodiment of the present invention fortification device 1. In this embodiment the device 1 swings upward via use of hinge means 50 by grasping the bottom of frame 41 in this embodiment (no handle version), and then the device can be folded upward around the hinge into a position similar to that of FIG. 1c covering the window 30 and preventing entry. Shown in this embodiment is latching means 55 on frame 41 which is used to lock the device 1 into place when it attaches manually or by an automatic means (such as by spring means) to latch grabbing means 56 when the device 1 is in its protective position. This embodiment can be returned to its lowered position by releasing the latch and folding the device back to the down position or letting gravity take it to that lowered position. While not shown, this embodiment could also have a framing means mounted around the window 30 which the frame 41 fits into when folded upward to create a seal between the device and the door 10.

What I claim is:

1. A safety device to reinforce a classroom door window comprising:
a) a piece of entry resistant material sufficient to cover the door window;
b) a means for attaching the material to the classroom door beneath the door window;
c) a means for moving the material from beneath the door window to a position completely covering the door window; and
d) a means for removably locking the material in position completely covering the door window.

2. A safety device according to claim 1 wherein the entry resistant material is semi opaque.

3. A safety device according to claim 1 wherein the entry resistant material is opaque.

4. A safety device according to claim 1 wherein the entry resistant material is non-opaque.

5. A safety device according to claim 1 wherein the entry resistant material is opaque.

6. A safety device according to claim 1 wherein the entry resistant material is slidably movable to a position completely covering the door window.

7. A safety device according to claim 4 where the entry resistant material is slidably via a pair of slide tracks.

8. A safety device according to claim 1 wherein the entry resistant material is foldably movable to a position completely covering the door window.

9. A safety device according to claim 1 wherein the device is removably locked in place via use of a plurality of latches.

10. A safety device according to claim 1 wherein the device can be unlocked from the opposite side of its attachment via a keying means.

11. A safety device according to claim 1 wherein the entry resistant material is a safety wire mesh.

12. A safety device according to claim 1 wherein the entry resistant material is a plurality of metal bars.

13. A safety device according to claim 1 wherein the entry resistant material is a thin entry resistant plastic.

14. A safety device according to claim 1 which comprises one or more assist handles to aid in moving the device to a position covering the door window.

15. A safety device according to claim 1 wherein there is a spring means to aid in moving the device to a position covering the door window.

16. A safety device according to claim 1 wherein moving the device from a position on the bottom portion of the door to a position covering the door window engages a locking means which locks the door in a closed position.

17. A safety device according to claim 1 wherein the entry resistant material is held in a frame.

18. A method of securing the inside portion of a classroom door window in an emergency comprising:
a) positioning a piece of entry resistant material over the inside portion door window; and
b) removably locking the material in place such that it completely covers the inside portion door window;
wherein the entry resistant material is positioned on a bottom portion of the classroom side of the classroom door prior to positioning over the window.

19. A method according to claim 18 which further comprises locking the door in a closed position when the entry resistant material is positioned over the window.

20. A method according to claim 18 wherein the entry resistant material can be positioned over the window manually.

21. A method according to claim 18 wherein the entry resistant material can be positioned over the window automatically.
